(19) United States
(12) Patent Application Publication
(10) Pub. No.: US 2016/0043817 A1
(43) Pub. Date: Feb. 11, 2016

(54) METHODS AND APPARATUS FOR LOCALITY BASED BROADCASTING

(71) Applicant: RSS Technologies, LLC, Jacksonville, FL (US)

(72) Inventors: James Handoush, Jacksonville, FL (US); William Sandberg, Jacksonville, FL (US); Nitin Deshmukh, Jacksonville, FL (US)

(21) Appl. No.: 14/803,966

(22) Filed: Jul. 20, 2015

Related U.S. Application Data
(60) Provisional application No. 62/026,384, filed on Jul. 18, 2014.

(51) Int. Cl. H04H 20/61; H04H 20/72; H04W 4/02

(52) U.S. Cl. CPC H04H 20/61; H04W 4/02; H04H 20/72

(57) ABSTRACT

The present disclosure relates to methods and apparatus for anonymously broadcasting locality based event information. More particularly, the present disclosure relates to broadcasting local event information from a portable broadcast device to multiple mobile devices, wherein the multiple mobile devices may be located within the vicinity of the local event or may subscribe to receiving event information about that locality.

### CROSS-REFERENCE TO RELATED APPLICATION

This application claims priority to and the full benefit of U.S. Provisional Patent Application Ser. No. 62/026,384, filed Jul. 18, 2014, and titled “METHODS AND APPARATUSES FOR TRANSMITTING AND RECEIVING BROADCAST MESSAGES”, the entire contents of which are incorporated herein by reference.

### FIELD OF DISCLOSURE

This invention relates to methods and apparatus for broadcasting multimedia and location data. More particularly, the present invention relates to an electronic device that may be used to capture one or more of: static image, videos, sound bites, global position, time, date, and text. The data are then broadcast to subscribers based upon an origination location.

### BACKGROUND

Traditionally, when a party wanted to share multimedia data, such as photographs or videos, the party captured the multimedia data with a digital camera or mobile device with a camera and uploaded the data to a personal website or social media webpage, including YouTube, Facebook, Twitter, and Instagram, to share experiences with friends, family, and subscribers. The multimedia viewing would not always be available to anyone and everyone because of many parties wishing to keep their identity private. The multimedia data often would be shared much later than the data were captured by the party and would take a long time to upload.

Vine and Vimeo are examples of sites that allow users to upload short video clips while sites like SoundCloud allow users to upload sound bites and full-length songs. Facebook, Twitter, and Instagram allow a party to upload and broadcast a photograph or video with text with a # (hashtag) in front of a word or phrase that would hyperlink the word or phrase after the #, making it searchable. For example, an uploaded photograph that includes #miami would allow for another party to click on #miami. A search results page will appear with every other multimedia post that includes #miami. However, searching for #miami along with a particular date, time, and precise GPS coordinates of the event in the multimedia file is not allowed or available. Also, #miami does not necessarily mean Miami, Fla.; there are other cities named Miami. There currently is no way to specify which Miami.

Additionally, the broadcasting of the data is not anonymous. The parties use social networking by creating a user account where a user can be identified by a retained IP address and then uploading the multimedia data under the user account profile on the social networking website. A party may choose to set his/her user account profile to private, thus allowing only select parties to view the uploaded multimedia data.

Real-time transmission and broadcasting of multimedia data is not available on many social networking websites like Twitter, Facebook, and Instagram. A party must first capture the multimedia data, save it to the mobile device, and then upload to the social media site rather than have the multimedia data stream simultaneously with the capture of an image or recording of a video. Twitter, however, does provide a ticker with hashtag text that are trending at the moment to show users which words or phrases are most popular. Twitter does not provide a way to perform a filtered search of trending hashtag text.

YouTube has the ability for users to broadcast live video to subscribers and the general public. For example, MTV broadcasted live highlights from Ultra Music Fest. However, the live broadcasting feature is not accessible for everyone to use. Some cities have cameras posted on various streets and satellites and provide the public with a link to view the live camera footage. Although, this broadcast is in real time, there is no way for a consumer to focus on specific events, and the viewers are limited to only those cameras.

Some social networking sites, including FourSquare, allow for users to check in to a business or other location. The name of the location is then posted with or without a photograph or video. For example, a party will use the mobile application for Instagram and capture a picture at Starbucks and check in. The photograph will be broadcasted with a hyperlinked “Starbucks.” A user may then click on the hyperlinked “Starbucks” to see a map with Starbucks and could see other photographs from other users that were uploaded at that location. However, a check-in is not available for every location and is not precise.

More recently, mobile applications such as Radius, Circle, and Find my Friends allow a party to see when a social media contact is near them. These applications are limited to finding only people a party knows and does not have a way of searching for events within a particular radius. These applications also do not allow the subscribers to receive automatically or have the option to receive updates with multimedia posts that were or are being captured within a defined radius relative to the subscriber.

Furthermore, a party does not have a method of capturing multimedia that can be used to anonymously capture and simultaneously broadcast unfortunate events such as crimes like vandalism where the multimedia footage will assist with criminal reporting and suspect identification.

### SUMMARY

Accordingly, the present disclosure provides apparatus and methods for determining a location; capturing one or more of various multimedia data and time of data capture; and broadcasting the captured data to a subscribing audience. In some embodiments, a broadcasting user may add annotations, such as hyperlinked text to the multimedia file. In one aspect, in some embodiments, a broadcasting user acting as a source of data and/or annotations to be broadcast may anonymously transmit captured data to be broadcast to a server, and the server may broadcast data to subscribing members wherein the subscribing members who receive the data and/or annotations are not aware of.

In another aspect, data may be broadcast to subscribing users according to selected subscriber criteria. For example, a first subscriber criteria may specify that a subscriber receive all broadcast data within a designated geographic area. A second subscriber criteria may specify that a subscriber receive data based upon a search criteria associated with the subscriber. In some embodiments, searchable data may be made available via a website that includes search filters.

In still another aspect the present disclosure may provide for methods and apparatus that are efficient for anonymously capturing and transmitting a witnessing of a crime or emergency situation to emergency responders and members of the public concerned about a certain type of crime or emergency in a designated area.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing apparatus capable of facilitating a location-based broadcast of event information communications, where the apparatus includes: a communications network access device for accessing a server in logical communication with a communications network; and executable software stored on the communications network access device and executable on demand, the software operative with the communications network access device to cause the network access device to: generate a broadcast message including one or more of text image data and audio data, where the broadcast communication includes data descriptive of an occurrence of a local event in a defined geographic location; generate a scope of broadcast for the broadcast message; transmit the broadcast message to the server via the communications network, where the server is configured to receive the broadcast message and transmit the broadcast message to one or more subscriber network access devices configured to receive a broadcast associated with the defined geographic location. Other embodiments of this aspect include corresponding computer systems, apparatus, and computer programs recorded on one or more computer storage devices, each configured to perform the actions of the methods.

Implementations may include one or more of the following features: The computing apparatus where the one or more broadcast messages are categorized by one or both of the server and the network access device by an event type. The computing apparatus where the one or more subscriber network access devices may include a defined group of recipients. The computing apparatus where the one or more subscriber network access devices may be located in the defined geographic area for broadcast. The computing apparatus where the broadcast message is generated anonymously. The computing apparatus where broadcast message is generated under a pseudonym. The computing apparatus where the at least one geographic preference includes the predefined geographic location. The computing apparatus where the at least one geographic preference includes a current location of the computing apparatus. The computing apparatus where the one or more broadcast messages are categorized by event type. The computing apparatus where the subscription information further includes at least one preferred event type, where the preferred event type indicates an interest in receiving one or more broadcast messages categorized by the preferred event type. The broadcast server where the network access device is further caused to associate submitter with an anonymous user id, where personal identification information is not required. The broadcast server where the network access device is further caused to store broadcast data for predetermined amount of storage time and destroy broadcast data after the predetermined amount of storage time. The broadcast server where the predetermined amount of storage time is user specified. The broadcast server where the network access device is further caused to store historical data on broadcast types The broadcast server where the network access device is further caused to store historical data on broadcast volumes The broadcast server where the network access device is further caused to store historical data on broadcast locations The broadcast server where the network access device is further caused to store historical data on time broadcast messages are received. The broadcast server where the network access device is further caused to analyze the broadcast message for content type. Implementations of the described techniques may include hardware, a method or process, or computer software on a computer-accessible medium.

One general aspect includes a computing apparatus capable of facilitating a location-based broadcast of event information communication, where the apparatus includes: a communications network access device for accessing a server in logical communication with a communications network; and executable software stored on the communications network access device and executable on demand, the software operative with the communications network access device to cause the network access device to receive broadcast subscription information including at least one geographic preference, where the broadcast subscription information indicates an interest in receiving one or more broadcast messages associated with the at least one geographic preference; to transmit the broadcast subscription to an external server, where the external server is configured to store the at least one geographic preference; to receive a broadcast message including one or more of text or multimedia, where the broadcast message indicates the occurrence of an event in a predefined geographic location, where the predefined geographic location is in accordance to the at least one geographic preference. Other embodiments of this aspect include corresponding computer systems, apparatus, and computer programs recorded on one or more computer storage devices, each configured to perform the actions of the methods.

Implementations may include one or more of the following features: The computing apparatus where the at least one geographic preference includes the predefined geographic location. The computing apparatus where the at least one geographic preference includes a current location of the computing apparatus. The computing apparatus where the one or more broadcast messages are categorized by event type. The computing apparatus where the subscription information further includes at least one preferred event type, where the preferred event type indicates an interest in receiving one or more broadcast messages categorized by the preferred event type. The broadcast server where the network access device is further caused to associate submitter with an anonymous user id, where personal identification information is not required. The broadcast server where the network access device is further caused to store broadcast data for predetermined amount of storage time and destroy broadcast data after the predetermined amount of storage time. The broadcast server where the predetermined amount of storage time is user specified. The broadcast server where the network access device is further caused to store historical data on broadcast types. The broadcast server where the network access device is further caused to store historical data on broadcast volumes. The broadcast server where the network access device is further caused to store historical data on broadcast locations. The broadcast server where the network access device is further caused to store historical data on time broadcast messages are received. The broadcast server where the network access device is further caused to analyze the broadcast message for content type. Implementations of the described techniques may include hardware, a method or process, or computer software on a computer-accessible medium.

One general aspect includes a broadcast server capable of facilitating a location-based broadcast of event information communication; where the broadcast server includes: a communications network access device for accessing a server in logical communication with a communications network; and executable software stored on the communications network access device and executable on demand, the software operative with the communications network access device to cause the network access device to: receive a broadcast message from an external computing device of a submitter, receive location data associated with the broadcast message, associate location data with at least one subscription geographic area, receive broadcast category type associated with the broadcast message, broadcast the broadcast message to at least one external device of a subscriber subscribing to the at least one subscription geographic area. Other embodiments of this aspect include corresponding computer systems, apparatus, and computer programs recorded on one or more computer storage devices, each configured to perform the actions of the methods.

Implementations may include one or more of the following features: the broadcast server where the network access device is further caused to associate submitter with an anonymous user id, where personal identification information is not required; the broadcast server where the network access device is further caused to store broadcast data for predetermined amount of storage time and destroy broadcast data after the predetermined amount of storage time. In some aspects, the predetermined amount of storage time may be user specified. The network access device may be further caused to store historical data, including, for example, broadcast types, broadcast volumes, broadcast locations, or the time broadcast messages are received. The network access device may further be caused to analyze the broadcast message for content type. Implementations of the described techniques may include hardware, a method or process, or computer software on a computer-accessible medium.

One general aspect includes the broadcast server where the network access device is further caused to take action according to content type. Other embodiments of this aspect include corresponding computer systems, apparatus, and computer programs recorded on one or more computer storage devices, each configured to perform the actions of the methods.

The details of one or more examples of the disclosure are set forth in the accompanying drawings and the description below. The accompanying drawings that are incorporated in and constitute a part of this specification illustrate several examples of the disclosure and, together with the description, serve to explain the principles of the disclosure: other features, objects, and advantages of the disclosure will be apparent from the description, drawings, and claims herein.

### DESCRIPTION OF THE DRAWINGS

FIG. 1 illustrates an exemplary embodiment of a broadcaster observing an exemplary local event.

FIG. 2 illustrates an exemplary embodiment of a handheld device with broadcaster graphical user interface (GUI).

FIG. 3 illustrates an exemplary embodiment of a home graphical user interface (GUI) 335 of a handheld device.

FIG. 4 illustrates an exemplary embodiment of a subscriber broadcast graphical user interface (GUI) on a handheld device.

FIG. 5 illustrates an exemplary local event, wherein the local event may comprise a criminal activity.

FIG. 6 illustrates an exemplary embodiment of a subscriber home page graphical user interface (GUI) of a handheld device.

FIG. 7 illustrates an exemplary embodiment of a processing and interface system.

FIG. 8 illustrates exemplary method steps for receiving and transmitting broadcast messages.

The foregoing and other features and advantages of the disclosure will be apparent from the following, more particular description of preferred examples of the disclosure, as illustrated in the accompanying drawings.

### DETAILED DESCRIPTION

### Glossary

Broadcaster: as used herein refers to a party who observes a local event and submits information regarding the local event, wherein the submitted information may be transmitted as a broadcast. For example, the local event information may comprise a textual description, a captured image, or other type of multimedia capable of conveying an aspect of the local event.

Locality: as used herein refers to a defined geographic location, for example, based on GPS coordinates, zip codes, addresses, city limits, neighborhoods, or combinations thereof.

Local Event: as used herein refers to a locally occurring event, such as, for example, a social happening, criminal activity, sporting events, or any other personally observable activity that may be described and/or captured.

Subscriber: as used herein refers to a party who subscribes to receive broadcasts of local events. In some embodiments, a subscriber may select specific broadcast subscription, which may customize the broadcasts received.

The present disclosure relates generally to the anonymous transmission of broadcasts about local events from a broadcaster to subscribers. Subscribers may elect to receive broadcasts related to local events occurring within a specified locality, such as a city, a radius around their current location, or a radius around a particular venue of interest. Such communications may allow information to reach an interested audience without requiring prior personal relationships or an exchange of personal information. In some embodiments, a submitter may broadcast using a pseudonym or an anonymous user identification.

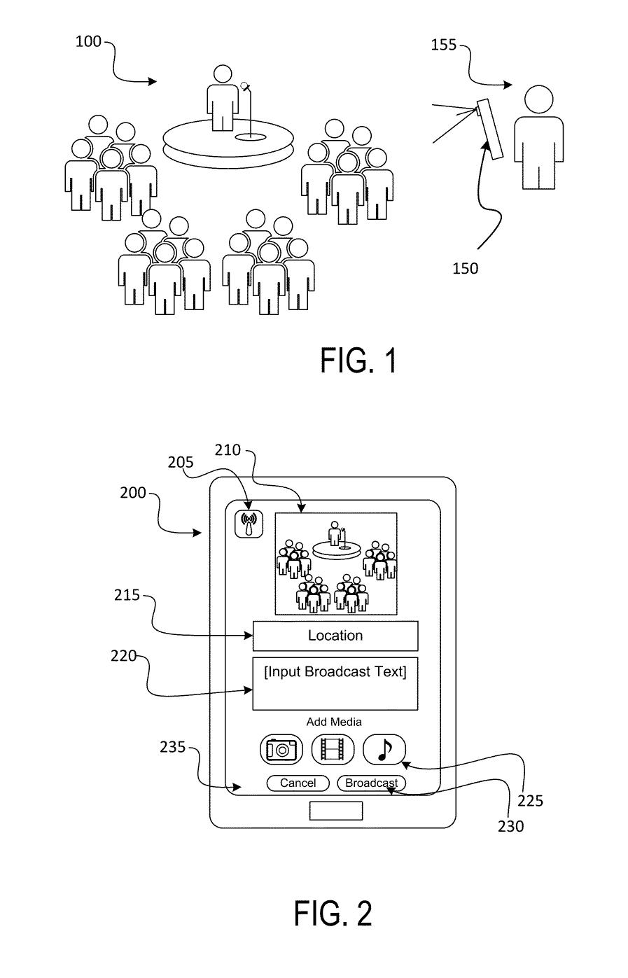

Referring now to FIG. 1, an exemplary broadcaster 155 is illustrated observing an exemplary local event 100. A local event may include, or example, a social event, a sporting event, or a criminal activity. A broadcaster 155 may observe the local event 100 and determine that local event 100 may be noteworthy or newsworthy. The broadcaster 155 may believe information relating to the local event 100 may be of interest to subscribers. For example, the local event 100 may be a secret performance by a popular singer, wherein a broadcast may alert subscribers to attend.

An anonymous broadcast regarding such a local event 100 may be considered unreliable, and the broadcaster 155 may capture multimedia of the local event 100 with a handheld device 150, such as a smartphone or tablet. In some aspects, captured multimedia may be confirmation of the local event 100 and/or may add information that may not be as effective if conveyed as text. As another example, a broadcaster 155 may witness a disaster local event, such as tornado, and the broadcaster 155 may use the handheld device 150 and capture image data of a tornado or may choose to stream a video for a live broadcast to subscribers. In some embodiments, the broadcaster 155 may include text forms that may be trackable in social media, such as hashtag text. In some aspects, a subscriber may share broadcasts through social media, wherein utilizing trackable text may be useful.

Referring now to FIG. 2, an exemplary handheld broadcasting device 200 with geospatial determination capability is illustrated. The geospatial determination capability includes electromechanical components for providing a geospatial location of the handheld broadcasting device 200. A location may include a Cartesian Coordinate, such as a GPS location, or a street address. In some embodiments, a handheld broadcasting device 200 may receive input from a user that specifies a geospatial designation, such as a performance venue, a stadium, an airport or a street intersection. The handheld broadcasting device 200 will display a broadcaster graphical user interface (GUI) 235 (as illustrated). In some embodiments, the broadcaster GUI 235 may present a program icon 205, which may confirm that a user may be working in the intended program. In some aspects, captured multimedia 210 may be presented, wherein a user may preview how the captured multimedia 210 may be broadcasted.

In some implementations, a location 215 may be automatically listed as the current location of the handheld broadcasting device 200, for example based on GPS coordinates. In some aspects, GPS coordinates of the handheld broadcasting device 200 may prompt location options, wherein a user may select a locality relevant to the local event. For example, where the local event may be a social event at a private clubhouse, the relevant locality may comprise the gated community associated with the private clubhouse. In contrast, where the local event may comprise a display of holiday fireworks, the locality may comprise a specific radius around the display, such as five miles, wherein subscribers within that area may be able to see the display or at least be able to drive to an area where the fireworks may be visible.

In some embodiments, the broadcaster GUI 235 may prompt the broadcaster to input descriptive text in a text box 220. The descriptive text may describe the local event or may complement the captured multimedia, wherein the descriptive text may emphasize the newsworthy or noteworthy aspects of the local event. In some aspects, the broadcaster GUI 235 may optionally prompt the broadcaster to add media, for example, by presenting multimedia capture icons 225, wherein a broadcaster may select to add audio data, video data, or image data. In some embodiments, a broadcaster may include multiple multimedia data with a single broadcast. In other exemplary embodiments, the broadcaster may include one captured multimedia 210, wherein clicking on a multimedia capture icon 225 may allow a broadcaster to replace the currently attached captured multimedia 210. In some embodiments, the broadcaster GUI 235 may prompt the broadcaster to select a transmission icon 230, wherein a broadcaster may elect to submit the broadcast or cancel the broadcast. In some embodiments, the user may define the transmission scope of broadcast, wherein the user may identify the relevant locales or event types.

In some embodiments, a broadcaster may select to capture a photograph by clicking an on-screen multimedia capture icon 225. A handheld broadcasting device 200 may be programmed to capture a photograph of a certain size or image quality. A broadcaster may select to capture a video by clicking an on-screen video record icon, such as the multimedia capture icon 225. A handheld broadcasting device 200 may be programmed to capture video data based on predefined attributes such as quality and file size. A broadcaster may select to capture an audio recording by clicking an on-screen audio record icon, such as a multimedia capture icon 225. In some embodiments, the handheld broadcasting device 200 may be programmed to capture photographs in burst mode.

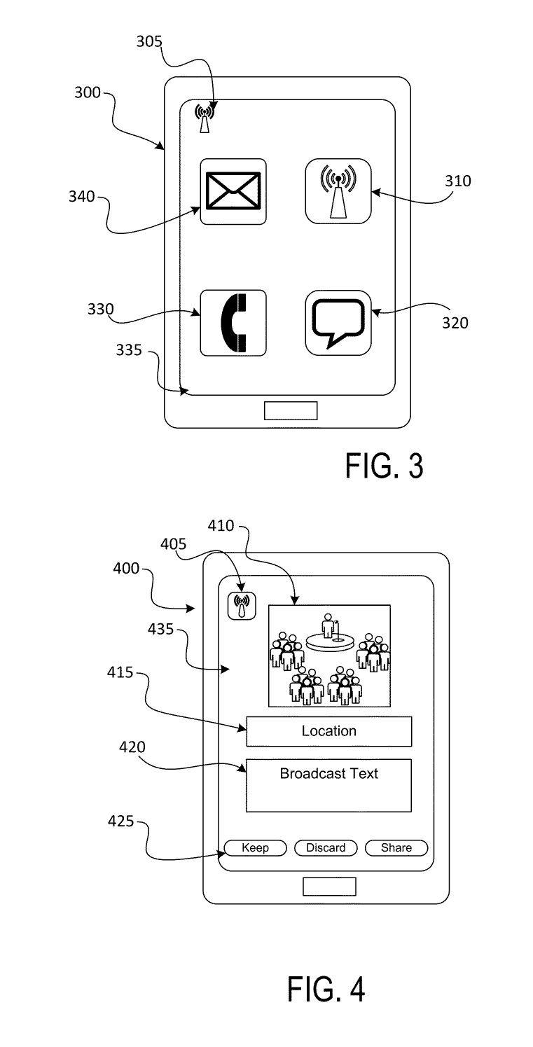

Referring now to FIG. 3, an exemplary home graphical user interface (GUI) 335 of a handheld device 300 is illustrated. In some embodiments, a home GUI 335 may present multiple application icons 310, 320, 330, 340, such as a mail icon 340, a call icon 330, a text icon 320, and a broadcast icon 310. In some aspects, the home GUI 335 may indicate to a subscriber when an unread broadcast may be received, such as by a broadcast indicator 305. The subscriber may select the broadcast icon 310 or acknowledge the broadcast indicator 305, wherein the selection or acknowledgement may prompt display of the broadcast.

Referring now to FIG. 4, an exemplary subscriber broadcast graphical user interface (GUI) 435 on a handheld device 400 is illustrated. In some embodiments, similarly to a broadcaster GUI 235, such as illustrated in FIG. 2, the subscriber broadcast GUI may display a program icon 405. In some embodiments, a broadcast may display to a subscriber in a similar layout to the layout display of the broadcaster GUI 235, such as illustrated in FIG. 2, wherein the subscriber broadcast GUI 435 may comprise a captured multimedia 410, a location 415, and a broadcast text 420. In some embodiments, the broadcast text 420 may comprise a subjective description of a local event, wherein the subjective description may be written from the perspective of the broadcaster.

In some embodiments, the subscriber broadcast GUI 435 may prompt the subscriber to respond to the broadcast, for example by presenting response icons 425. For example, the response icons 425 may allow the subscriber to keep, discard, or share the broadcast. In other examples, the response icons 425 may allow the subscriber to submit a responsive broadcast, wherein the subscriber may broadcast multimedia and/or descriptive text related to the local event of the broadcast. For example, the subscriber may disagree with the broadcast and may broadcast contrasting information, such as a photograph of a different angle, wherein the different angle may show that there actually may be very few people in the audience.

Alternately, the subscriber may also be in attendance of the local event and want to emphasize the content of the broadcast, wherein the responsive broadcast may add supporting multimedia or description.

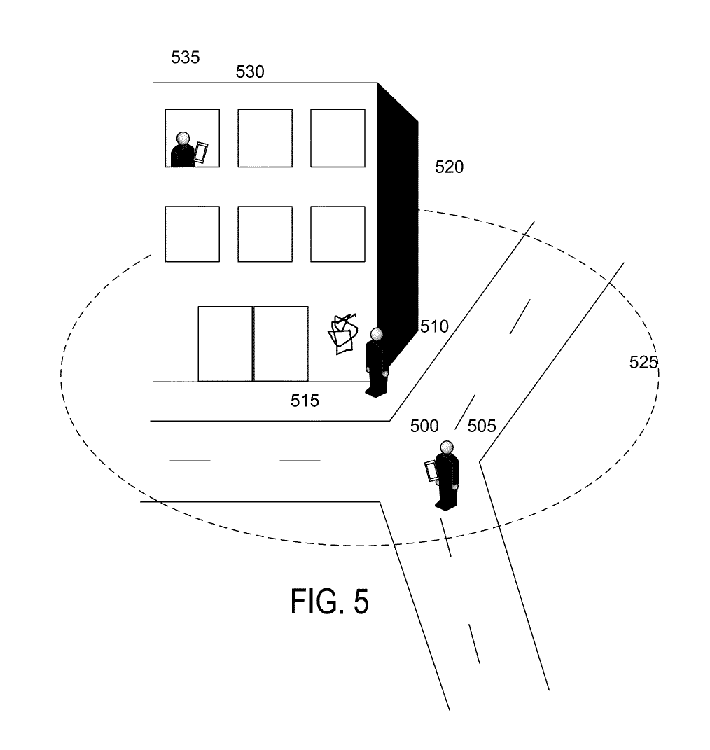

Referring now to FIG. 5, an exemplary embodiment of a local event, wherein the local event may comprise a criminal activity, is illustrated. In some embodiments, a broadcaster 500 may witness a criminal 510 committing a crime of graffiti 515. Broadcaster 500 may input a broadcast in a broadcast device 505, such as a smart phone, wherein the broadcaster 500 may capture an image, such as a photograph or video, of the graffiti 515 on apartment building 520. Subscriber 535 may subscribe to broadcasts within a locality, wherein the locality may comprise, for example, a distance from a current location or a radius 525 from an apartment building 520. Subscriber 535 may be interested in local events within the radius 525, for example because subscriber 535 may live in apartment building 520 and may want to be notified of emergency situations and crimes.

In some embodiments, the subscriber 535 may want to know whether it may be safe to take her dog outside and may rely on broadcasts received by a subscriber device 530, wherein the broadcast may comprise multimedia data captured within the radius 525. In some aspects, receipt of the broadcast of graffiti 515 may prompt subscriber 535 to stay inside and share the broadcast information with others in the apartment building 520, first-response teams, or any other specific people or to the public in general. In some embodiments, specific categories of broadcasts, such as fires or violent crimes, may be directly transmitted to emergency response for the relevant locality.

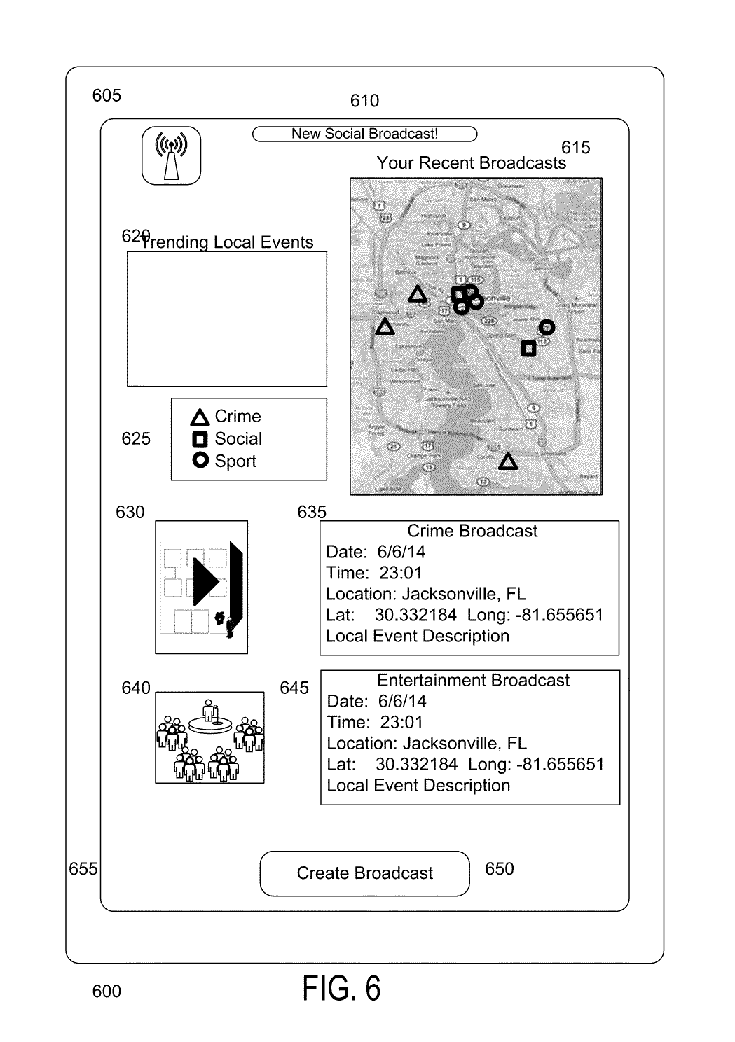

Referring now to FIG. 6, an exemplary subscriber home page graphical user interface (GUI) 655 of a handheld device 600 is illustrated. In some embodiments, a subscriber home page GUI 655 may display a program icon 605. Where broadcasts may be tracked or monitored for trends, the subscriber home page GUI 655 may display trending local events 620. In some embodiments, a subscriber may also be a broadcaster, wherein an individual may receive and transmit broadcasts.

A graphical user interface may be optimized for a range of handheld devices, including for example, smartphone, tablet, camera, watch, digital recorder, desktop computer, laptop, television, wherein a screen may be responsive to tactile controls. Similarly, a GUI may be configured to display based on a range of operating systems, including, for example, iOS, Android, Windows, Blackberry, and Linux.

In some embodiments, the subscriber homepage GUI 655 may display multimedia data on a ticker that may stream multimedia in real time. In some aspects, a ticker may display basic information about broadcasted multimedia data in a compressed form, which may allow more multimedia files displayed in a shorter amount of time. In some embodiments, a subscriber may hover over a ticker multimedia file to pause a ticker, wherein a multimedia file may be opened in a new window to display a full photograph, audio file, or video file in conjunction with the text portion of the broadcast. Multimedia data displayed on a ticker may be limited by subscriber settings and preferences.

The subscriber home page GUI 655 may display a locality image 615, such as a map, wherein locations of recent broadcasts may be indicated. In some embodiments, a broadcasting device may distinguish between categories of local events, such as criminal activities, social events, or sporting events. In such aspects, a subscriber home page GUI 655 may organize broadcasts by category, wherein a subscriber may filter broadcasts by category. In some aspects, the locality image 615 may indicate different categories of local events, such as by using unique icons in combination with an icon legend 625.

In some implementations, a subscriber may view multiple broadcasts in the same screen. In some such aspects, a subscriber home page GUI 655 may display captured multimedia 630, 640 and broadcast information 635, 645 for multiple broadcasts. In some aspects, a subscriber may view the captured multimedia 630, 640 from the subscriber home page GUI 655. Alternately, the subscriber may select the captured multimedia 630, 640, which may prompt display of a multimedia graphical user interface.

In some embodiments, a subscriber may be able to filter broadcasts or create broadcast settings, wherein a subscriber may control predefined attributes of broadcasts. In some aspects, a filter may sort current broadcasts, and broadcast settings may limit broadcast access for future broadcasts. Customization may be a paid service, wherein a subscriber may submit periodic payments. In some implementations, a subscriber may create a profile, wherein the profile may comprise preferences, such as locality or categorical interest. As an illustrative example, a subscriber may filter only multimedia that was captured within the past 5 minutes at Starbucks on the corner of 1^{st} street and 2^{nd} avenue in Jacksonville, Fl.

In some embodiments, a subscriber may save multimedia files, share multimedia files, ignore multimedia files, or block multimedia files of a certain type, including, for example, audio files. Similarly, multimedia may be limited based on file size, such as image data larger than 10 Mb. Multimedia settings may allow a subscriber to manage monthly data limits.

In some aspects, a subscriber may utilize a free version that may have advertisements, limited viewing, limited filter capabilities, and limited ability to save and share multimedia, for example. In contrast, a paid version may limit advertisements and may allow subscribers to customize broadcast receipt settings. A free version may allow a subscriber to subscribe to receive broadcasts from a locality without requiring login, as access to profile settings may not be required.

In some embodiments, advertisements may be displayed on one or both the broadcaster or subscriber GUI. The advertisements may be specifically relevant, for example, to a locality, time of the year, time of the day, or category of broadcast. In still further aspects, where event trends may be monitored, advertisements may be tailored to trending events. For example, late night trending local events may comprise nightclub offerings, and customized advertisements may be related to cab services or restaurants that may be open after closing time of nightclubs. As another illustrative example, trending local events may comprise mugging and car-jacking crimes, and customized advertisements may relate to personal protection products or car insurance.

In some embodiments, a broadcast system may save broadcast information, such as the multimedia data, textual description, or broadcast source locality. In other embodiments, the broadcast system may track general trends of objective data, for example by recognizing and storing occurrence of specific text or GPS coordinates of one or both the broadcaster or subscriber device. Storing and analyzing a portion of the broadcast information may allow the server to extract, sort, and store larger quantities of meaningful data. Tracking extracted data may increase privacy for broadcasters and subscribers, as the content of each broadcast may be temporarily stored for transmission. Extraction of objective data may protect the identities of broadcasters and subscribers.

Alternatively, a broadcast system may store the content of broadcasts, such as the textual description, multimedia, or identity of the broadcaster. In some implementations, the broadcast system may develop a library of broadcast content, wherein, for example, a broadcaster, subscriber, government entity, or broadcast system provider may access previously transmitted or received broadcasts.

In some embodiments, the broadcast system may selectively store broadcast content, such as where specific content or content type may be recognized. For example, the broadcast system may recognize inappropriate content, such as defined by law or terms of use, wherein identification of the inappropriate may prompt storage of the content of the broadcast and/or the identity of the broadcaster. Such an embodiment may allow for effective monitoring of the broadcasts with limited invasion of privacy. In some implementations, where inappropriate content may be identified, the broadcast may be blocked, wherein subscribers may not be exposed to the inappropriate content. In some aspects, portions of a broadcast may be analyzed in isolation. For example, where a broadcast comprises appropriate text accompanying a pornographic multimedia file, the broadcast system may block the multimedia and transmit the text to subscribers.

In some embodiments broadcast data may be stored for predetermined amount of storage time and destroy broadcast data after the predetermined amount of storage time, such as defined by user or provider. In some aspects, historical data related to the broadcast data may be stored and analyzed. For example, historical data may comprise broadcast, content, or event types, broadcast volumes, broadcast locations, times broadcast messages are received, or the like.

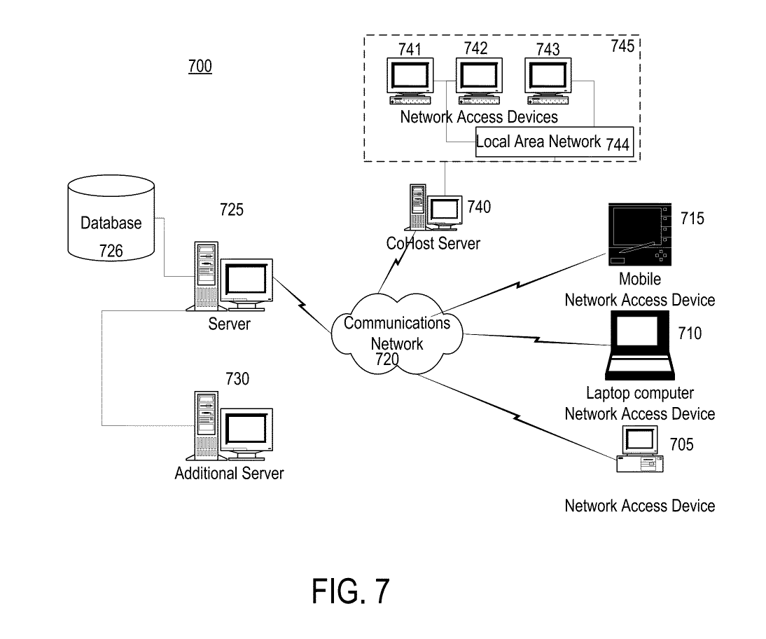

Referring now to FIG. 7, an exemplary processing and interface system 700 is illustrated. In some aspects, access devices 715, 710, 705, such as a mobile device 715 or laptop computer 710 may be able to communicate with an external server 725 though a communications network 720. The access devices 715, 710, 705 may comprise submitter or subscriber network access devices, wherein the access devices 715, 710, 705 may comprise computing devices installed with executable software. The external server 725 may be in logical communication with a database 726, which may comprise data related to subscriber information and associated profile or locality information. In some embodiments, the server 725 may be in logical communication with an additional server 730, which may comprise supplemental processing capabilities.

In some aspects, the server 725 and access devices 705, 710, 715 may be able to communicate with a cohost server 740 through a communications network 720. The cohost server 740 may be in logical communication with an internal network 745 comprising network access devices 741, 742, 743 and a local area network 744. For example, the cohost server 740 may comprise an advertiser, such as a cab company, or a social network, such as Facebook or Instagram.

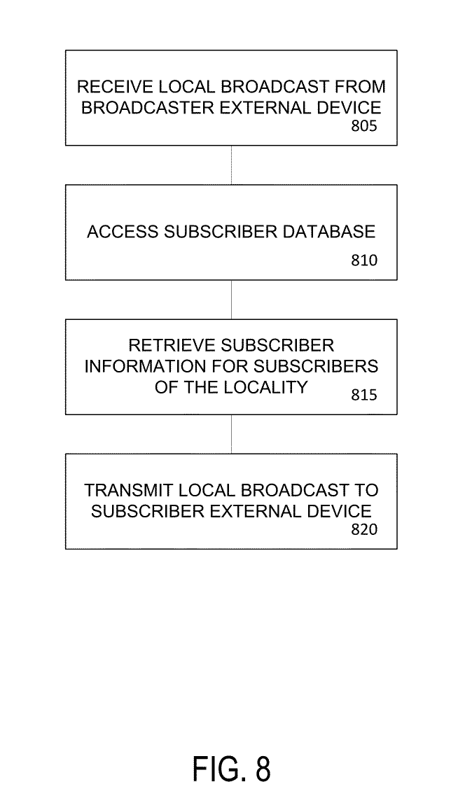

Referring now to FIG. 8, exemplary method steps for receiving and transmitting broadcast messages are illustrated. In some embodiments, a processing system, such as illustrated in FIG. 7, may execute steps 805-820, wherein one or more of the system components may execute the method steps. In some embodiments, at 805, a broadcast message may be received, wherein the broadcast message may comprise one or both a text portion and a multimedia file, such as described in FIGS. 2-5. In some aspects, at 810, a subscriber database may be accessed, and at 815, subscriber information may be retrieved for subscribers of the locality associated with the broadcast message. In some embodiments, at 820, the broadcast message may be transmitted to a subscriber external device, such as illustrated and described in FIGS. 3-5.

A number of examples of the present disclosure have been described. While this specification contains many specific implementation details, these should not be construed as limitations on the scope of any disclosures or of what may be claimed, but rather as descriptions of features specific to particular examples of the present disclosure.

Certain features that are described in this specification in the context of separate examples can also be implemented in combination in a single embodiment. Conversely, various features that are described in the context of a single embodiment can also be implemented in combination in multiple examples separately or in any suitable sub-combination. Moreover, although features may be described above as acting in certain combinations and even initially claimed as such, one or more features from a claimed combination may, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

While the disclosure has been described in conjunction with specific examples, it is evident that many alternatives, modifications, and variations will be apparent to those skilled in the art in light of the foregoing description. Accordingly, this description is intended to embrace all such alternatives, modifications, and variations as fall within its spirit and scope.

Although shown and described in what is believed to be the most practical and preferred examples, it may be apparent that departures from specific designs and methods described and shown will suggest themselves to those skilled in the art and may be used without departing from the spirit and scope of the disclosure. The present disclosure is not restricted to the particular constructions described and illustrated but should be constructed to cohere with all modifications that may fall within the scope of the appended claims.

What is claimed is:

1. A method for providing a location-based broadcast, the method comprising:
determining a geographic location with a handheld broadcasting device with geospatial determination capability;
generating a broadcast message with the handheld broadcasting device, the broadcast message comprising one or more of: text, image data, and audio data, and wherein the broadcast message comprises data descriptive of an occurrence of a local event local to the determined geographic location;
generating a transmission scope of broadcast for the broadcast message; and
transmitting the broadcast message from the handheld broadcasting device to a server via a communications network, wherein the server is configured to receive the broadcast message and transmit the broadcast message to one or more subscriber handheld broadcasting devices configured to receive a broadcast associated with the determined geographic location.

2. The method of claim 1, wherein the broadcast message is categorized with an event type by one or both of the server and the handheld broadcasting device.

3. The method of claim 1, wherein the one or more subscriber handheld broadcasting devices comprise a determined group of recipients.

4. The method of claim 1, wherein the one or more subscriber handheld broadcasting devices are located in the defined geographic location for broadcast.

5. The method of claim 1, wherein the broadcast message is generated anonymously.

6. The method of claim 1, wherein broadcast message is generated under a pseudonym.

7. A method capable of facilitating a location-based broadcast of an event information communication, wherein the method comprises the steps of:
entering broadcast subscription information into a network access device the broadcast subscription information comprising one or more geographic preferences and an of an interest in receiving one or more broadcast messages associated with the one or more geographic preferences;
sending the broadcast subscription to an external server via a communications network, wherein the external server is configured to store the one or more geographic preferences; and
receiving via the communications network one or more broadcast message comprising one or more of text or multimedia and an indication of an occurrence of an event in a predefined geographic location, wherein the predefined geographic location is in accordance to the one or more geographic preferences.

8. The method of claim 7, wherein the one or more geographic preferences comprise the predefined geographic location.

9. The method of claim 7, wherein the one or more geographic preferences comprise a current location of the method.

10. The method of claim 7, wherein the one or more broadcast messages are categorized by event type.

11. The method of claim 10, wherein the subscription information further comprises at least one preferred event type, wherein the preferred event type indicates an interest in receiving one or more broadcast messages categorized by the preferred event type.

12. A broadcast server capable of facilitating a location-based broadcast of event information communication; wherein the broadcast server comprises:
a communications handheld broadcasting device configured to access a server in logical communication with a communications network; and
executable software stored on the communications handheld broadcasting device and executable on demand, the software operative with the communications handheld broadcasting device to cause the handheld broadcasting device to:
receive a broadcast message from an external computing device of a submitter,
receive location data associated with the broadcast message,
associate location data with at least one subscription geographic area,
receive broadcast category type associated with the broadcast message,
broadcast the broadcast message to at least one external device of a subscriber subscribing to the at least one subscription geographic area.

13. The broadcast server of claim 12, wherein the handheld broadcasting device is further caused to associate submitter with an anonymous user identification, wherein personal identification information is not required.

14. The broadcast server of claim 12, wherein the handheld broadcasting device is further caused to store broadcast data for predetermined amount of storage time and destroy broadcast data after the predetermined amount of storage time.

15. The broadcast server of claim 14, wherein the predetermined amount of storage time is user specified.

16. The broadcast server of claim 14, wherein the handheld broadcasting device is further caused to store historical data on broadcast types.

17. The broadcast server of claim 14, wherein the handheld broadcasting device is further caused to store historical data on broadcast volumes.

18. The broadcast server of claim 14, wherein the handheld broadcasting device is further caused to store historical data on broadcast locations.

19. The broadcast server of claim 14, wherein the handheld broadcasting device is further caused to store historical data on time broadcast messages are received.

20. The broadcast server of claim 12, wherein the handheld broadcasting device is further caused to analyze the broadcast message for content type and caused to take action based upon the content type.
